(19) United States
(12) Patent Application Publication
(10) Pub. No.: US 2008/0125078 A1
(43) Pub. Date: May 29, 2008

(54) Mobile information device for performing emergency notification

(75) Inventor: Yasuaki Morimoto, Kawasaki (JP)

Correspondence Address: GREER, BURNS & CRAIN, 300 S WACKER DR, 25TH FLOOR, CHICAGO, IL, 60606, US

(73) Assignee: Fujitsu Limited, Kawasaki-shi (JP)

(21) Appl. No.: 12/001,541

(22) Filed: Dec. 12, 2007

Related U.S. Application Data
(63) Continuation of application No. PCT/JP2005/011473, filed on Jun. 22, 2005.

(51) Int. Cl. H04M 11/04

(52) U.S. Cl. 455/404.2

(57) ABSTRACT

When the intensity of stimulus to a mobile information device from an external environment has attained a certain level or above, the mobile information device transmits an emergency code to a reference station. The reference station transmits an emergency response code to the mobile information device so as to forcibly activate the location-determination control unit. The current position information on the mobile information device obtained by the location-determination control unit is transmitted to the emergency notification destination.

### CROSS REFERENCE TO RELATED APPLICATION

This application is a continuation application of International PCT Application No. PCT/JP2005/011473 which was filed on Jun. 22, 2005.

### BACKGROUND OF THE INVENTION

1. Field of the Invention

The present invention relates to a mobile information device used for performing an appropriate notification in cases of emergency such as accidents, crime incidents, or the like.

2. Description of the Related Art

As an example of a conventional mobile information service system for checking the status of moving automobiles, Patent Document 1 discloses a configuration as described below.

In this system, users' mobile information devices mounted on automobiles receive information such as the latest status of roads, weather, and destinations that are transmitted from the information provider company. Also, position information of automobiles acquired by navigation systems and sensor data acquired through various sensors mounted on the automobiles are analyzed by using self-diagnosis functions included in the automobiles, and the analyzed information is transmitted from the mobile information devices to an information provider company and an automobile company in real time. The automobile company monitors, at all times, the utilization status of automobiles on the basis of the analyzed information received, and provides appropriate information responsive to the status to the mobile information devices carried by the users.

The main characteristic of this conventional technique is a configuration in which data acquired through various sensors mounted on automobiles are analyzed by the self-diagnosis functions in the automobiles prior to transmission, and the analysis results are always transmitted to the information provider company and automobile company, such that users' mobile information devices can always receive appropriate information.

Also, as a conventional vehicle information management system that follows up maintenance and inspection on vehicles by exchanging data on users' vehicles between the users' terminals and a vehicle information management company, Patent Document 2, for example, discloses a technique as described below.

In this system, vehicle data is extracted from electronic control units mounted on vehicles in order to be stored on memory cards, and is transferred to hard disks in the users' terminals. The users' terminals access a users-only-web site prepared by the vehicle information management company, and the diagnostic information is displayed on a Web page.

Also, the vehicle data can be transferred from electronic control units to mobile phones, and the diagnosis information is displayed on the Web page of the mobile phones instead of the users' terminals. Thereby, the diagnosis information is provided in real time.

However, the above described automobile diagnosis systems have the problems as described below.

When a fatal emergency such as a traffic accident occurs while the mobile information service or the diagnostic service is being provided to a user in real time, the service provider cannot deal with this emergency.

### Patent Document 1:

Japanese Patent Application Publication No. 2002-230658

### Patent Document 2:

Japanese Patent Application Publication No. 2003-011747

### SUMMARY OF THE INVENTION

It is an object of the present invention to automatically perform an appropriate emergency notification when the user is involved in emergencies such as accidents, crime incidents, or the like.

The mobile information device according to the present invention comprises a sensor, a position-determination control unit, a notification destination table, and a notification control unit.

The sensor detects a stimulus from the external environment in order to output a signal responsive to the intensity of the stimulus. The position-determination control unit obtains position information. The notification destination table stores information of a notification destination used for emergency notification.

The notification control unit monitors the signal output from the sensor, and transmits a prescribed emergency code to a reference station when the monitored signal has attained a certain level or above. Then, the notification control unit activates the position-determination control unit in order to obtain the current position, and transmits the obtained position information to the emergency notification destination stored in the notification destination table.

The sensor, the position-determination control unit, the notification destination table, and the notification control unit may for example correspond respectively to a shock sensor 116, a GPS (Global Positioning System) control unit 115, an emergency notification destination table 114, and a controller 112 shown in FIG. 1 that will be described later.

### BRIEF DESCRIPTION OF THE DRAWINGS

FIG. 1 shows a configuration of a mobile phone;

FIG. 2 shows a configuration of an emergency notification system;

FIG. 3 shows a first flowchart for an emergency notification process;

FIG. 4 shows a second flowchart for the emergency notification process;

FIG. 5 shows an arrangement of speakers and microphones;

FIG. 6 shows a configuration of an information processing device; and

FIG. 7 shows a method of providing a program and data.

### DESCRIPTION OF THE PREFERRED EMBODIMENTS

Hereinafter, the best modes for carrying out the invention will be explained in detail, by referring to the drawings.

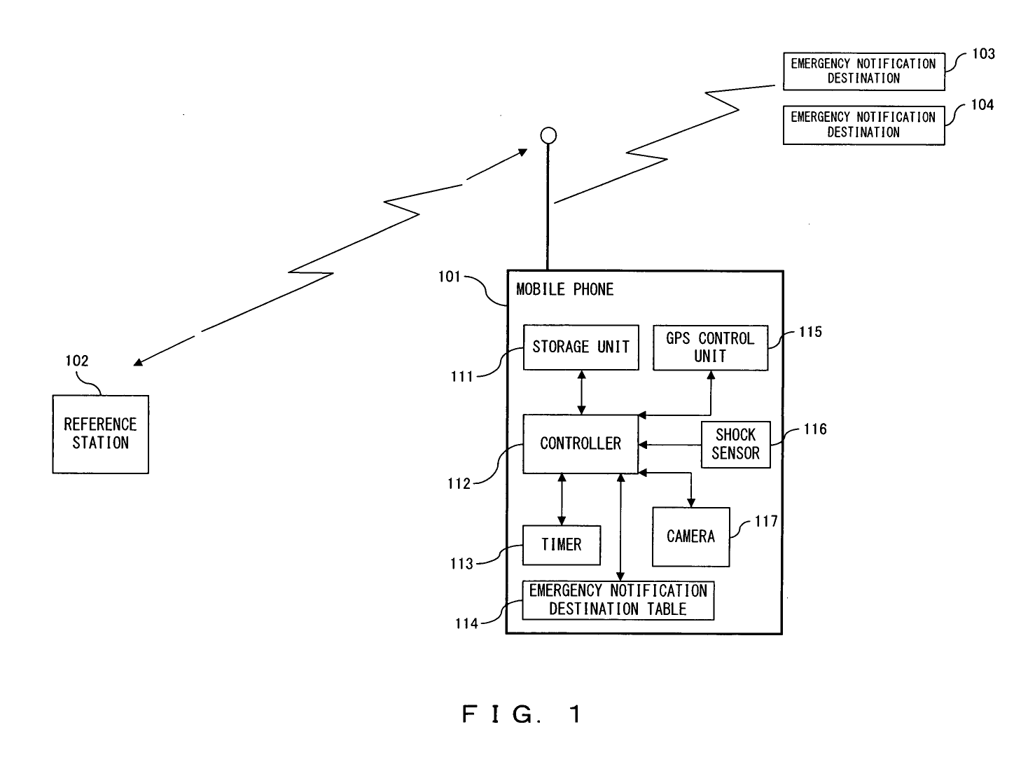

FIG. 1 shows a configuration example of a mobile phone used in the emergency notification system. A mobile phone 101 in FIG. 1 comprises a storage unit 111, a controller 112, a timer 113, an emergency notification destination table 114, a GPS control unit 115, a shock sensor 116, and a camera 117. The emergency notification destination table 114 is stored in a medium such as a memory unit or the like in order to store the notification destinations (telephone numbers, e-mail addresses, and the like) of family members or the like that the user has registered beforehand.

As an example, a case is assumed where only the user is carrying the mobile phone 101 and he/she has become unconscious due to an accident while moving from one place to another in an automobile, or a case where the user cannot move even though he/she remains conscious. In this kind of emergency, the mobile phone 101 obtains the current position of the user in a coordinated manner with the GPS function provided by the telecommunication carrier company under contract with the user.

The shock sensor 116 detects the shock that the mobile phone 101 receives from the external environment, and outputs a signal responsive to the magnitude of the shock to the controller 112. When the shock sensor outputs a signal that has attained a certain level or above and the controller 112 receives the signal, the GPS control unit 115 automatically operates to detect the position information of the mobile phone 101. The controller 112 stores the detected position information in the storage unit 111, and stores the latest position information in a memory unit in the controller 112.

The controller 112 automatically transmits the position information and an emergency occurrence information to the reference station 102 of the telecommunication carrier company and to the notification destinations 103 and 104 registered in the emergency notification destination table 114. An emergency notification message to be transmitted to the notification destinations 103 and 104 is stored in the storage unit 111 beforehand.

When detecting a signal from the shock sensor 116, the controller 112 makes the transition to an emergency mode immediately regardless of which state (standby mode, calling/communicating mode, or a status in which other functions are operating) the mobile phone 101 is in. Thereafter, the controller 112 transmits a transmission instruction to the mobile phone 101. Upon receiving this transmission instruction, the mobile phone 101 makes transition to the transmission state and automatically transmits the emergency code prescribed by the telecommunication carrier company to the reference station 102.

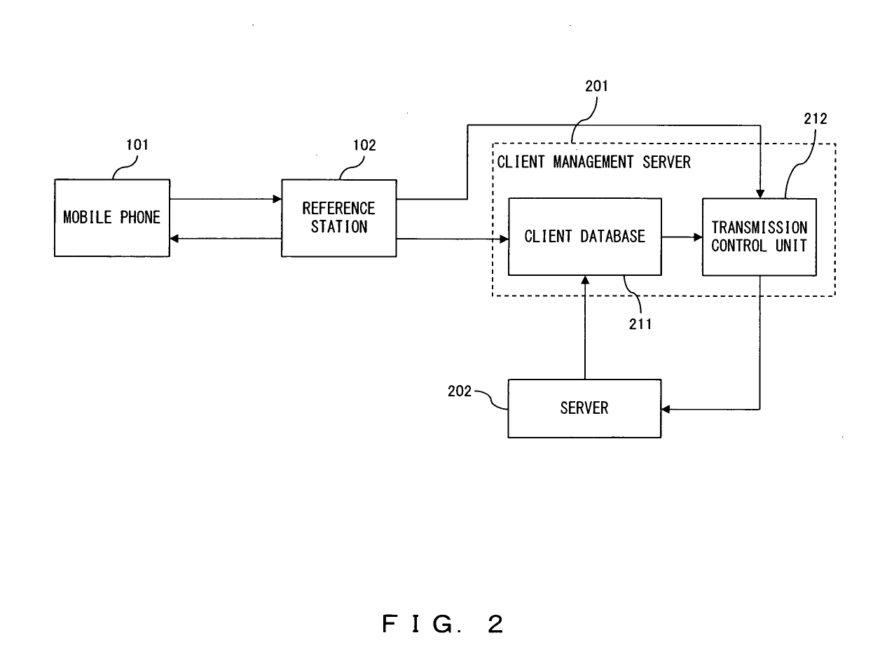

FIG. 2 shows an example of a configuration of an emergency notification system in which a telecommunication carrier company notifies the casualty insurance company of the occurrence of the emergency. The communication in the above system is based on the assumption that the user and the insurance company have an agreement to perform a notification such as the above.

The system shown in FIG. 2 comprises the mobile phone 101, the reference station 102, a client management server 201 in the telecommunication carrier company, and a server 202 in the casualty insurance company. The client management server 201 comprises a client database 211 and a transmission control unit 212.

The client database 211 stores information such as name, telephone number, the presence or absence of a contract to use the GPS, the name of a contracting casualty insurance company, a client telephone number given in the contract of the insurance company, and the like for each client of the telecommunication carrier company. Among the above items, the name of the casualty insurance company and the telephone number given in the contract are registered in the client database 211 by the server 202 via a communication network.

When the emergency code is to be transmitted, the controller 112 forces the mobile phone 101 to change its mode into the telephone number reporting mode, and transmits to the reference station 102 the telephone number of the mobile phone 101 together with the emergency code. Thereby, the reference station 102 can identify the mobile phone 101.

Next, the reference station 102 transmits to the client management server 201 the telephone number of the mobile phone 101, and the transmission control unit 212 refers to the client database 211 in order to identify the casualty insurance company under contract with the user using the mobile phone 101. Thereby, the transmission control unit 212 can notify the casualty insurance company' s server 202 of the reception of the emergency code and the position information as soon as the transmission control unit 212 receives the position information of the mobile phone 101.

When the reference station 102 transmits the position information of the mobile phone 101 to the transmission control unit 212, the telephone number of the mobile phone 101 is added to the position information as identification information. The transmission control unit 212 refers to the client database 211 and checks whether or not the telephone number added to the position information is identical to the telephone number described in the contract.

Also, the reference station 102 uses an emergency response code in order to forcibly activate the GPS function in the mobile phone 101 even when the user has not entered into a contract to use the GPS with the telecommunication carrier company. When the mobile phone 101 receives the emergency response code from the reference station 102, the controller 112 causes the GPS control unit 115 to operate. The GPS control unit 115 performs the position determination by using the self positioning method or the remote positioning method, and acquires the position information.

In the self positioning method, the GPS control unit 115 calculates the position on the basis of the arrival times of radio waves from a plurality of reference stations except for the reference station 102 that manages the current position. Thereafter, the calculated position information is transmitted from the mobile phone 101 to the reference station 102.

In the remote positioning method, a central position-determination device (not shown) calculates the position of the mobile phone 101 on the basis of the arrival time of radio waves between the mobile phone 101 and a plurality of reference stations. In this case, the calculated position information is collected in the reference station 102, and the position information is transmitted also to the mobile phone 101. Thereby, the mobile phone 101 can transmit, to the notification destinations registered in the emergency notification destination table 114, not only the emergency notification message but also the position information.

However, a case can occur in which a user intentionally activates the emergency mode in order to acquire the position information even when it is not emergency. In order to avoid such usage, the controller 112 prohibits the position information acquired in the emergency mode from being displayed on the display screen of the mobile phone 101 and from being output through the speaker as audio information.

Also, the mobile phone 101 acquires the position information several times, thereby making it possible to confirm whether or not the user is moving from one place to another. When the user is not moving from one place to another, it implies a strong possibility that an accident has occurred, and when the user is moving from one place to another, it implies a strong possibility that a crime incident is occurring. Thereby, the receiver of the emergency notification can select an appropriate countermeasure on the basis of the position information and the position information is highly useful.

Further, when the mobile phone 101 receives the emergency response code from the reference station 102, the controller 112 activates a camera 117 and transmits the images picked up by the camera 117 together with the position information. By performing this control, the status of the users can be accurately recognized. However, also in this image transmission, the controller prohibits the images from being displayed on the screen of the mobile phone 101 in order to avoid usage that is against the original intent.

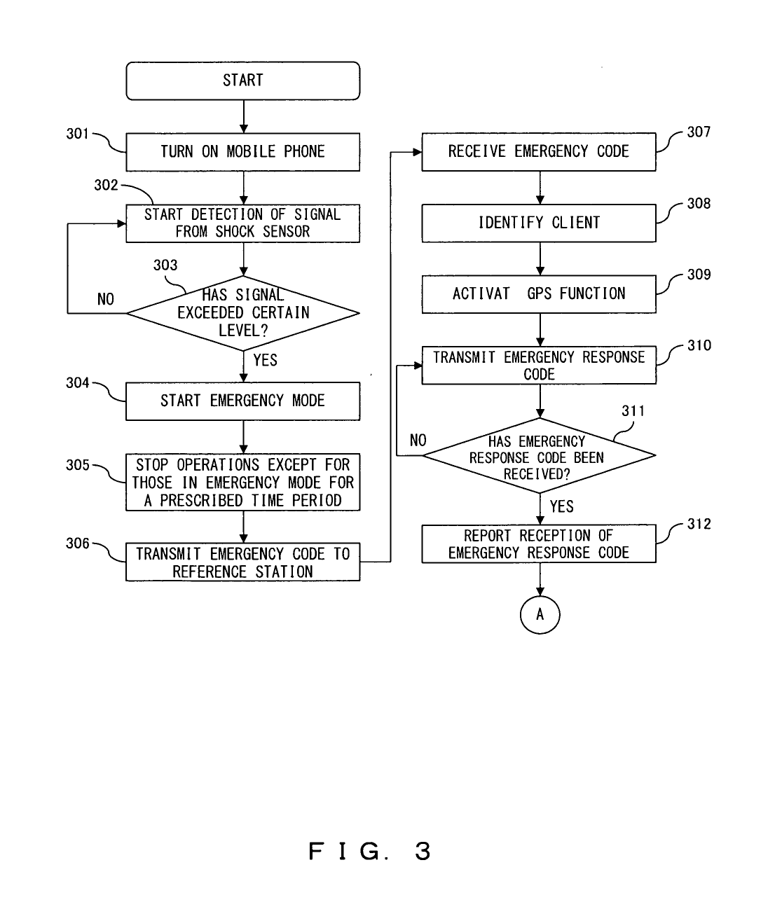

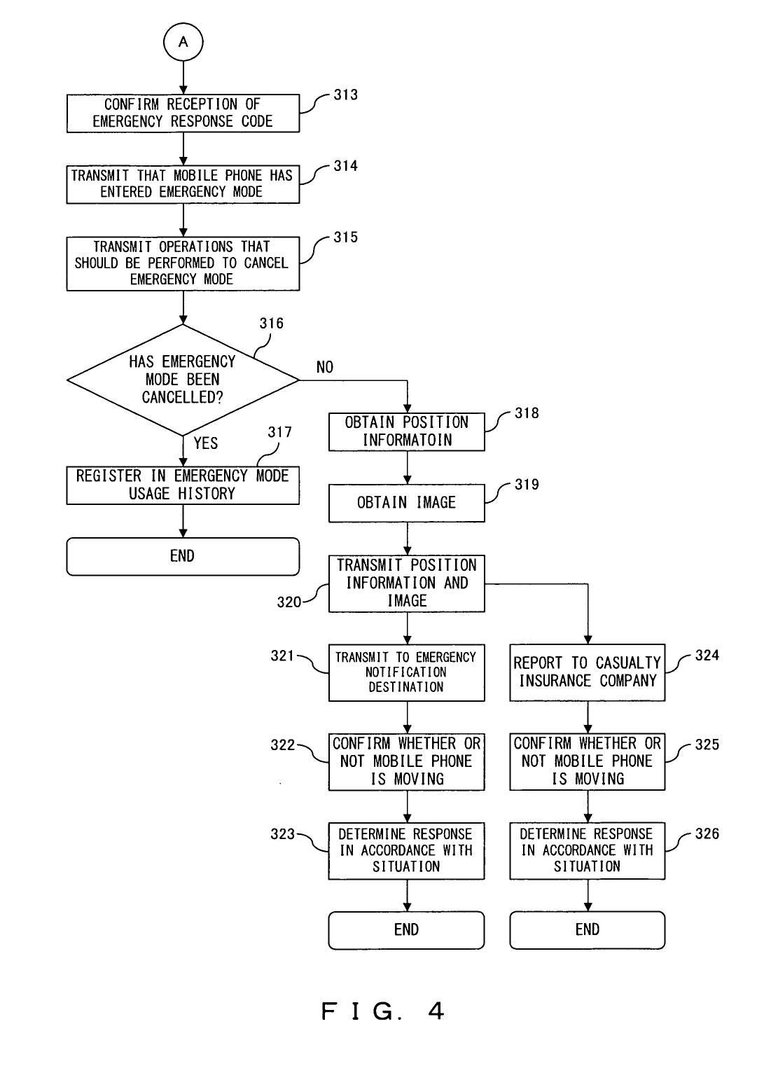

FIGS. 3 and 4 show a flowchart for the emergency notification process in the emergency notification system shown in FIGS. 1 and 2.

When the user turns on the mobile phone 101 (step 301), the shock sensor 116 operates, and the controller 112 starts to detect the signals from the shock sensor 116 (step 302). When detecting that the shock sensor 116 has output a signal having attained a certain level or above (step 303), the controller 112 prepares for emergency mode (step 304). Then, the user is notified that his/her mobile phone 101 is making the transition to emergency mode by means of the display on the screen and/or audio information. Also, the timer 113 is caused to calculate a prescribed time.

If the user cancels the counting by, for example, turning off the mobile phone 101 before the prescribed time elapses, the transition to the emergency mode is suspended, and when the mobile phone is turned on again, the mobile phone 101 can be used in the normal mode. When the prescribed time has elapsed, the controller 112 stops all the operations except for those in the emergency mode, and the mobile phone 101 makes the transition to the emergency mode (step 305). Thereafter, the timer 113 again calculates another prescribed time, and once this prescribed time has elapsed, the mobile phone 101 returns to the normal mode.

Next, the controller 112 changes the mode of the mobile phone 101 into the telephone number report mode, and transmits the prescribed emergency code and the telephone number to the reference station 102 and to the notification destinations registered in the emergency notification destination table 114 in order to report the occurrence of the emergency (step 306). Thereby, the parties notified of the emergency can prepare to respond to the emergency.

When receiving the emergency code (step 307), the reference station 102 searches the client management database 211 in order to identify the user and the mobile phone 101 that has transmitted the emergency code (step 308). Then, the reference station 102 transmits to the mobile phone 101 the control signal for causing the GPS control unit 115 to get ready (step 309).

Next, the reference station 102 transmits the emergency response code to the mobile phone 101 (step 310) in order to notify the mobile phone 101 of a preparation state of the reference station 102, and the mobile phone 101 confirms whether or not it has received the emergency response code (step 311). When the mobile phone 101 has received the emergency response code, it remits to the reference station 102 acknowledgement of the reception of the emergency response code (step 312). The transmission of the emergency response code is repeated by the reference station 102 for the prescribed number of times, and when there is no acknowledgement of the reception from the mobile phone 101, the process terminates.

When receiving the acknowledgement of the reception from the mobile phone 101 (step 313), the reference station 102 transmits the information expressing that the mobile phone 101 has entered the final emergency mode (step 314), and all the operations except for those in the emergency mode are completely stopped in the mobile phone 101.

Further, the reference station 102 transmits to the mobile phone 101 the operations that should be performed to cancel the emergency mode (step 315), and checks whether or not the emergency mode has been cancelled (step 316). This is for the purpose of avoiding incapacitating the phone due to a mistake made by a user, because none of the normal functions can be used in the emergency mode. However, when a prescribed time has elapsed, it becomes impossible to cancel the emergency mode.

When the emergency mode has been cancelled by the user, the reference station 102 registers in the client management database 211 the information expressing “mode cancellation” as the emergency mode usage history of that user (step 317). Then, it is determined that the user is not in an emergency, and the process terminates. When there is a user who transmits the emergency code a plurality of times and cancels the emergency mode each time, such user receives a warning from the telecommunication carrier company, and if the user is malicious, future emergency codes from this user are not accepted.

When an emergency mode remains without being cancelled for a prescribed time period, the controller 112 performs a control such that the position information is obtained by using the GPS control unit 115 (step 318). If the remote positioning method is used by the reference station 102 to obtain the position information, the reference station 102 transmits the position information to the mobile phone 101 as described above.

Next, the controller 112 performs a control such that the image is obtained from the camera 117 in the mobile phone 101 (step 319), and the obtained position information and image are transmitted to the reference station 102 and to the notification destinations registered in the emergency notification destination table 114 (step 320). When transmitting the above position information and image, it is also possible to transmit the emergency notification message to the emergency notification destinations. Also, in the case of the remote positioning method, only the image may be transmitted to the reference station 102. Thereafter, the position information and the image are repeatedly obtained at a prescribed time interval, and are transmitted continuously.

The receiver at the emergency notification destination continuously receives pieces of the position information and images from the mobile phone 101 (step 321), and confirms whether or not the mobile phone 101 is moving from one place to another on the basis of whether or not the received information changes (step 322). Thereby, it is possible to determine a response in accordance with the situation and rapidly make arrangements for the police, the ambulance, and the like (step 323).

Also, as shown in FIG. 2, the client management server 201 receives the position information and image from the reference station 102, and transfers the received information to the server 202 of the casualty insurance company identified by using the client database 211 (step 324). Thereby, the casualty insurance company confirms whether or not the mobile phone 101 is moving from one place to another (step 325) to determine a response in accordance with the situation (step 326).

The above explanation is based on the assumption that functions other than those in the emergency mode are all stopped in order to cope with the situation where the user transmits the emergency code for a purpose other than the emergency notification. However, it not always necessary to stop the normal functions of the mobile phone 101 in the emergency mode because to stop the calling functions may cause unnecessary confusion.

In this case, the timer 113 in the mobile phone 101 calculates the time, and after a prescribed time has elapsed, all the functions start to be recovered at prescribed time intervals. Then, in step 318, when receiving a call from the emergency notification destination having received the emergency notification, the controller 112 automatically sets the mobile phone 101 to an on-line state in order to permit the user to hear the voices or the like from the emergency notification destination. Thereby, even when the user cannot move, he or she can speak with the emergency notification destination if he or she remains conscious.

Thereafter, in step 319, a microphone in the mobile phone 101 catches audio information, and the controller 112 transmits to the reference station 102 and the emergency notification destination the caught audio information together with the position information and the image in step 320.

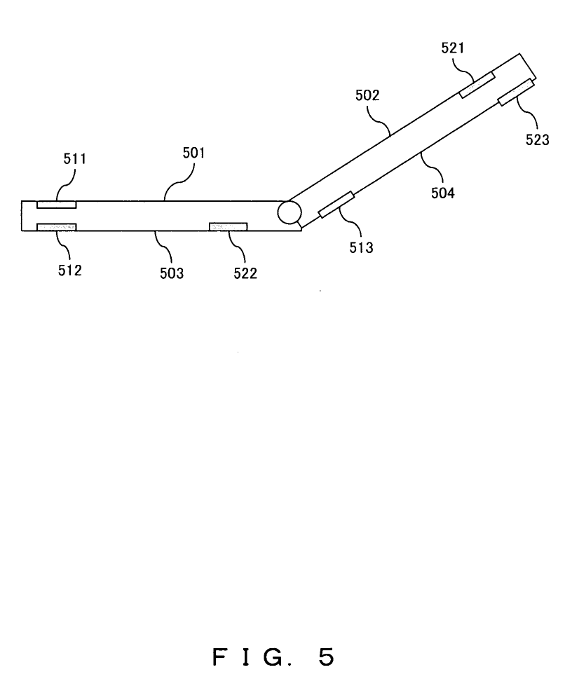

FIG. 5 shows an example of an arrangement of the speakers and the microphones in the mobile phone 101 for the calling functions in emergency. In the case of a folding mobile phone, usually, a microphone 511 is arranged on an internal surface 501 having operation buttons and a speaker 521 is arranged on a surface having the display device.

In addition to the above arrangement, microphones 512 and 513 and speakers 522 and 523 are arranged on the external surfaces 503 and 504, and thereby the call can be performed even when the mobile phone is in the folded state. In the emergency mode, the controller 112 performs control to switch the operational state such that the external microphones 512 and 513 and the external speakers 522 and 523 can operate. In this emergency mode, the microphones 512 and 513 pick up the user's voice or the environmental sounds around the mobile phone 101, and the party that has received the emergency notification judges the situation.

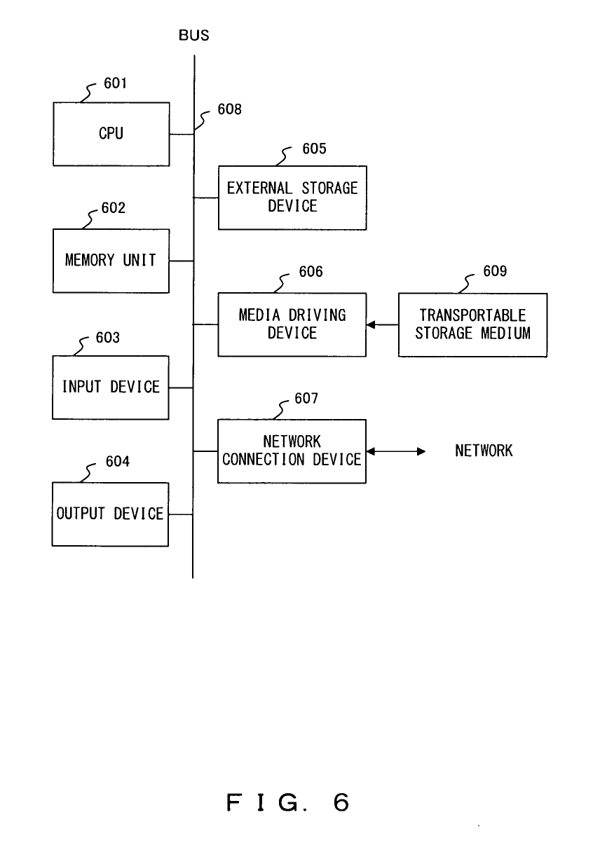

FIG. 6 shows a configuration example of an information processing device (computer) used as the reference station 102, the client management server 201, and the server 202 of the casualty insurance company. The information processing device shown in FIG. 6 includes a CPU (Central Processing Unit) 601, a memory unit 602, an input device 603, an output device 604, an external storage device 605, a media driving device 606, and a network connection device 607 in such a manner that they are connected to one another via a bus 608.

The memory unit 602 includes, for example, a ROM (Read Only Memory) device, a RAM (Random Access memory) device, or the like for storing a program and data used for the processing. The CPU 601 performs necessary processes by executing the program by using the memory unit 602. The transmission control unit 212 shown in FIG. 2 corresponds to the program executed on the memory unit 602.

The input device 603 is, for example, a keyboard, a pointing device, or the like, and is used for inputting instructions and information given by operators. The output device 604 is, for example, a display device, a printer, a speaker, or the like, and is used for outputting process results and questions to the operators.

The external storage device 605 is, for example, a magnetic disk device, an optical disk device, a magneto-optical disk device, a tape device, or the like. The information processing device stores in this external storage device 605 the program and data in order to load them into the memory unit 602 to use them as necessary. The external storage device 605 is also used as the client database 211 shown in FIG. 2.

The media driving device 606 drives a transportable storage medium 609 in order to access the information stored therein. The transportable storage medium 609 is an arbitrary computer readable storage medium such as a memory card, a flexible disk, an optical disk, a magneto-optical disk, or the like. Operators store the program and data in this transportable storage medium 609 in order to load them into the memory unit 602 to use them as necessary.

The network connection device 607 is connected to a communications network such as a LAN (Local Area Network), a WAN (Wide Area Network), or the like for converting data used for the communications. The information processing device receives the program and data from external devices via the network connection device 607, and loads them into the memory unit 602 to use them as necessary.

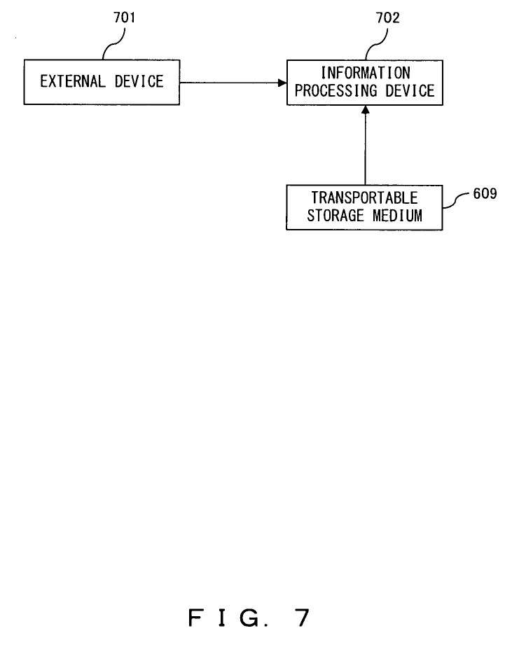

FIG. 7 shows a method of providing the program and data to the information processing device shown in FIG. 6. The program and data stored in the transportable storage medium 609 or the database in the in an external device 701 are loaded into the memory unit 602 in the information processing device 702. The external device 701 generates a carrier signal for carrying the program and data, and transmits the carrier signal to the information processing device 702 via an arbitrary transmission medium on a communications network. The CPU 601 executes the program by using the data for performing necessary processing.

In the embodiments explained above, a mobile phone is used as a device for performing an emergency notification. However, arbitrary information devices (such as a PDA (Personal Digital Assistant), a notebook computer, and the like) that can be carried by a user may be used instead of a mobile phone.

Also, as a sensor for detecting the occurrence of an emergency, not only a shock sensor, but also a sound sensor, a temperature sensor, a pressure sensor, a gas sensor, and the like can be used. These sensors detect stimuli from the external environment as described below.
(1) Sound sensor: Intensity change of sound such as explosions and the like
(2) Temperature sensor: Temperature change such as heat, cold, and the like
(3) Pressure sensor: Pressure change such as air pressure and the like
(4) Gas sensor: Concentration change such as carbon monoxide and the like

In the above explanation, a reference station of a telecommunication carrier company has been used as an example. However, it is also possible to use a base station (network server) corresponding to a reference station of the service provider company that implements the emergency notification service.

The service provider company may be a security company, for example.

Also, the position information may be acquired not only by the GPS, but also by a mobile information terminal or a reference station by using position information transmission devices or the like provided in various areas or by processing the camera images, audio information and the like.

According to the present invention, an emergency notification including position information and the like is performed to a prescribed notification destination when an emergency such as an accident, a crime incident, or the like occurs to a user carrying a mobile information device. Accordingly, a party that has received the emergency notification can judge the situation of the user on the basis of the received position information and the like, and can rapidly make arrangements for the police, an ambulance, and the like.

What is claimed is:

1. A mobile information device, comprising:
a sensor for detecting a stimulus from an external environment and for outputting a signal responsive to an intensity of the stimulus;
a position-determination control unit for obtaining position information;
a notification destination table for storing information of an emergency notification destination; and
a notification control unit for monitoring the signal output from the sensor, for transmitting a prescribed emergency code to a reference station when the signal attains a certain level or above, for obtaining current position information by activating the position-determination control unit, and for transmitting the obtained position information to the emergency notification destination stored in the notification destination table.

2. The mobile information device according to claim 1, wherein:
the position-determination control unit obtains the current position information of the mobile information device on the basis of arrival times of radio waves to a plurality of reference stations.

3. The mobile information device according to claim 1, wherein:
the position-determination control unit obtains the current position information of the mobile information device upon receiving from the reference station an emergency response code indicating reception of the emergency code.

4. The mobile information device according to claim 1, wherein:
the sensor detects a shock from an external environment, and outputs a signal responsive to an intensity of the shock.

5. The mobile information device according to claim 1, further comprising:
a timer for keeping track of time for a prescribed time period, wherein:
when the signal output from the sensor has attained the certain level or above, the notification control unit activates the timer and notifies a user of a transition to an emergency mode, and when the user performs cancellation before the prescribed time period has elapsed, the notification control unit does not transmit the emergency code to the reference station.

6. The mobile information device according to claim 5, wherein:
when the notification control unit makes the transition to the emergency mode and transmits the emergency code, the notification control unit activates the timer and stops functions other than those in the emergency mode until a prescribed time period elapses.

7. The mobile information device according to claim 1, wherein:
when the notification control unit transmits the emergency code to the reference station, the notification control unit selects a mode in which a telephone number is reported to the reference station.

8. The mobile information device according to claim 1, further comprising:
a camera, wherein:
the notification control unit transmits an image picked up by the camera together with the position information.

9. The mobile information device according to claim 1, further comprising:
a microphone, wherein:
the notification control unit transmits audio information caught by the microphone together with the position information.

10. The mobile information device according to claim 1, further comprising:
a plurality of speakers and a plurality of microphones, wherein:
the notification control unit activates the plurality of speakers and the plurality of microphones after transmitting the emergency code to the reference station.

11. A method of performing an emergency notification, wherein:
a mobile information device detects a stimulus from an external environment, transmits a prescribed emergency code to a reference station when an intensity of the stimulus has attained a certain level or above, and forcibly activates a position-determination control unit of the mobile information device by receiving, from the reference station, an emergency response code indicating reception of the emergency code;
the position-determination control unit obtains current position information of the mobile information device on the basis of arrival times of radio waves to a plurality of reference stations; and
the mobile information device transmits the obtained position information to an emergency notification destination.
